(19) United States
(12) Patent Application Publication
(10) Pub. No.: US 2009/0267541 A1
(43) Pub. Date: Oct. 29, 2009

(54) LED LAMP CONTROL CIRCUIT HAVING POWER SAVING FUNCTION AND POWER SAVING CONTROL METHOD THEREOF

(75) Inventor: MING-YUAN HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/192,081

(22) Filed: Aug. 14, 2008

(30) Foreign Application Priority Data
Apr. 28, 2008 (CN) 200810301350.6

(51) Int. Cl. H05B 37/02

(52) U.S. Cl. 315/307

(57) ABSTRACT

A light emitting diode (LED) lamp control circuit having power saving function includes a control switch, a LED lamp, a battery, and a controller. The battery is connected to the LED lamp to supply power via the control switch. The controller is connected to the control switch and the battery to detect voltage values of the battery and control the control switch. The controller outputs different control signals to control the switching time of the control switch to drive the LED lamp to emit light at different intensity according to the voltage value of the battery.

### BACKGROUND

1. Field of the Invention

The present invention relates to a LED lamp control circuit having power saving function and power saving control method thereof.

2. Description of the Related Art

Traditionally, incandescent and fluorescent illuminating devices have been used as light sources for a long time. However, significant advances in the technology of LED have made LED lamps an attractive alternative for users, because of their long operating life, and high efficiency. Normally, a battery is configured to supply power to the LED, and the power is supplied continuously, leading to shorter battery life.

What is desired, therefore, is to provide a LED lamp control circuit having power saving function and power saving control method thereof, the working time of the LED lamp can be prolonged with better power usage.

### BRIEF DESCRIPTION OF THE DRAWINGS

FIG. 1 is a block diagram of a LED lamp control circuit in accordance with an embodiment of the present invention; and

FIG. 2 is a flowchart of an exemplary power saving control method for the LED lamp control circuit of FIG. 1.

### DETAILED DESCRIPTION

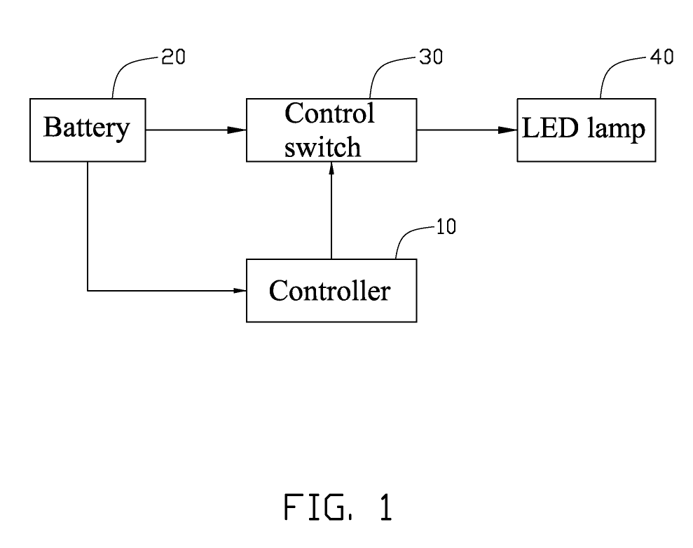

Referring to FIG. 1, a light emitting diode (LED) control circuit having power saving function in accordance with an embodiment of the present invention includes a controller 10, a battery 20 (a rechargeable battery, for instance), a control switch 30, and a LED lamp 40.

The battery 20 is connected to the LED lamp 40 to supply power via the control switch 30. The controller 10 is connected to the control switch 30 and the battery 20. The controller 10 outputs different control signals to control a switching time of the control switch 30 to drive the LED lamp 40 to emit light at different intensities according to the voltage value of the battery 20, and control the control switch 30 to turn off at a predetermined exhaustion point of the battery 20.

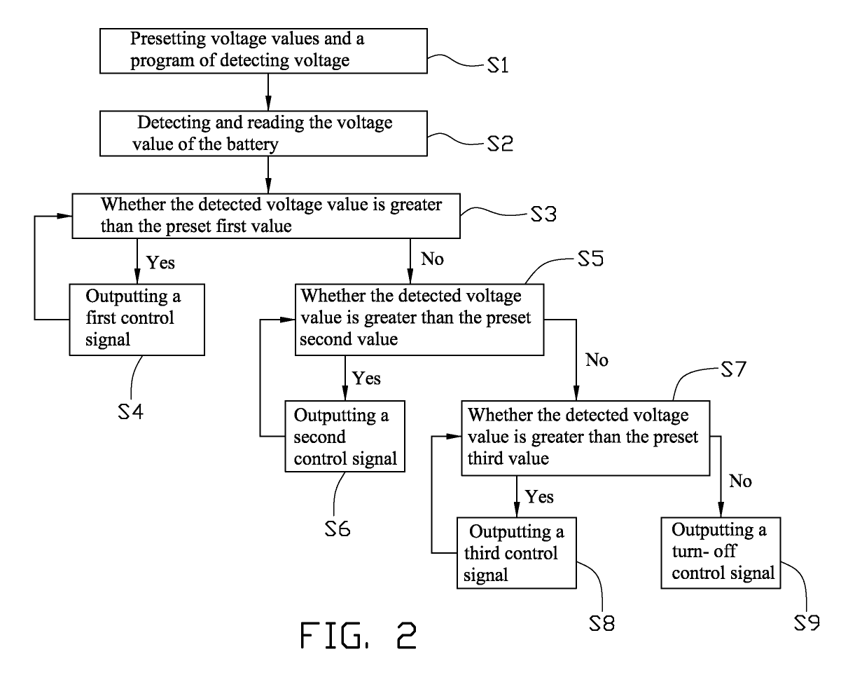

Referring to FIG. 2, an exemplary power saving control method of the LED lamp 40 utilizes the controller 10 to control the switching time of the control switch 30 to prolong work time of the LED lamp 40, thereby conserving power and prolonging the life of the battery 10.

The power saving control method of the LED lamp in accordance with an embodiment of the present invention includes:

Step 1, predetermining a program used to detect a voltage value of the battery 20, and for reading a first predetermined voltage value, a second predetermined voltage value, and a third predetermined voltage value from the controller 10. In the embodiment, the first, second, and third predetermined voltage values may be 11.8 volts (V), 11.4 V, and 11.1 V respectively.

Step 2, the controller 10 detects and reads the voltage value of the battery 20.

Step 3, the controller 10 compares the detected voltage value with the first predetermined voltage value 11.8V.

Step 4, upon a condition that the detected voltage value is greater than the first predetermined voltage value 11.8V, the controller 10 outputs a first pulse width modulation (PWM) signal to the control switch 30 to drive the LED lamp 40 to emit light at a first intensity, the duty cycle of the first PWM signal is greater than 40 percent. While the power of the battery 20 is continuously consumed, the controller 10 continuously reads the voltage value of the battery 20, and continues performing step 3 until the detected voltage value is no longer greater than the first predetermined voltage value 11.8V.

Step 5, upon a condition that the detected voltage value is equal to or less than the first predetermined voltage value such as 11.8 V predetermined, the controller 10 compares the detected voltage value with the second predetermined voltage value 11.4V and goes to step 6.

Step 6, upon a condition that the detected voltage value is greater than the second predetermined voltage value 11.4V, the controller 10 outputs the second PWM signal to the control switch 30 to drive the LED lamp 40 to emit light at a second intensity, the duty cycle of the second PWM signal is 40 percent. The power of the battery 20 is depleting continuously, the controller 10 continues detecting and reading the voltage value of the battery 20, and then continues performing step 5 until the detected voltage value is no longer greater than the predetermined second voltage value 11.4V.

Step 7, upon a condition that the detected voltage value is equal to or less than the second predetermined voltage value 11.4V, the controller 10 compares the detected voltage value with the third predetermined voltage value 11.1V and goes to step 8.

Step 8, upon a condition that the detected voltage value is greater than the third predetermined voltage value 11.1V, the controller 10 outputs the third PWM signal to the control switch 30 to drive the LED lamp 40 to emit light at a third intensity, the duty cycle of the PWM signal is 30 percent. The power of the battery 20 is depleting continuously, the controller 10 keeps on detecting and reading the voltage value of the battery 20, and then keeps on performing step 7 until the detected voltage value is no longer greater than the predetermined third voltage value 11.1V.

Step 9, upon a condition that the detected voltage value equal to the predetermined third voltage value 11.1V, the controller 10 outputs a control signal to turn off the control switch 30.

In this embodiment, the first, second, and third voltage values, the duty cycle of the first, second, and third PWM signal can be determined conveniently according to need. The third voltage value is a predetermined exhaustion point value of the battery 20. The number of the predetermined voltage values can be increased or decreased according to need.

The power saving control method of the LED lamp 40 can conserving the power of the battery thereby prolonging the usage time of the led lamp 40. The LED lamp 40 can be turned off when the battery 20 reaches a predetermined point of low power level.

It is to be understood, however, that even though numerous characteristics and advantages of the present invention have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A light emitting diode (LED) lamp control circuit with power saving function, comprising:
a control switch;
a LED lamp;
a battery connected to the LED lamp to supply power via the control switch; and
a controller connected to the control switch and the battery, the controller being capable of detecting voltage values of the battery and controlling the control switch;
wherein the controller outputs different control signals according to the voltage value of the battery to control the switching time of the control switch to drive the LED lamp emit light at different intensity.

2. The LED lamp control circuit as claimed in claim 1, wherein the controller controls the control switch to turn off the battery upon the condition that the voltage value detected by the controller is equal to a predetermined voltage value indicating a low power level of the battery.

3. The LED lamp control circuit as claimed in claim 1, wherein the different control signals are Pulse Width Modulation signals with different cycle duties.

4. The LED lamp control circuit as claimed in claim 1, wherein the battery is a rechargeable battery.

5. A power saving control method of the LED control circuit as claimed in claim 1, the method comprising:
predetermining a first voltage value, and a second voltage value less than the first voltage value;
detecting and reading the voltage value of the battery;
comparing the detected voltage value with the first and second predetermining voltage values;
providing the controller to output a first control signal to drive the LED lamp to emit light at a first intensity upon the condition that the detected voltage valued is greater than the predetermined first voltage value; and
outputting a second control signal to drive the LED lamp to emit light at a second intensity upon the condition that the detected voltage value is equal to or less than the first predetermined voltage value and greater than the predetermined second voltage value.

6. The control method as claimed in claim 5, wherein the controller predetermines a third voltage value, the control method further comprises:
outputting a third control signal to drive the LED lamp to emit light at a third intensity upon the condition that the voltage value detected is equal to or less than the second predetermined voltage value and greater than the predetermined third voltage value.

7. The control method as claimed in claim 5, wherein the controller predetermines a third voltage value, the control method further comprises:
outputting a control signal to turn off the battery to stop the LED lamp emitting light upon the condition that the voltage value detected is equal to the predetermined third voltage value.

8. The control method as claimed in claim 6, wherein the first voltage value, the second voltage value and the third voltage value are 11.8V, 11.4V and 11.1V respectively.
